(19) United States
(12) Patent Application Publication
(10) Pub. No.: US 2007/0279184 A1
(43) Pub. Date: Dec. 6, 2007

(54) Method Of Operating Multiple Vehicles Using Any Transmitter From A Programmed Group

(75) Inventors: Tejas B. Desai, Troy, MI (US); James P. Brecht, Shelby Township, MI (US); Sanjaya Dash, Macomb, MI (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS VDO AUTOMOTIVE CORPORATION, Auburn Hills, MI (US)

(21) Appl. No.: 11/751,808

(22) Filed: May 22, 2007

Related U.S. Application Data
(60) Provisional application No. 60/802,572, filed on May 22, 2006.

(51) Int. Cl. H04L 9/32

(52) U.S. Cl. 340/5.26; 340/825.72; 340/5.72; 340/5.64; 307/10.3; 340/426.36

(57) ABSTRACT

A method for sending and receiving transmissions for a remote keyless entry and immobilizer facilitates operation of multiple transmitters with multiple vehicles. A common secret key code stored in each transmitter and vehicle controller of the system is utilized to encrypt and decrypt information and data transmitted from the transmitter to the vehicle.

### CROSS REFERENCE TO RELATED APPLICATION

The application claims priority to U.S. Provisional Application No. 60/802,572 which was filed on May 22, 2006.

### BACKGROUND OF THE INVENTION

This invention generally relates to a method of transmitting data between a remote keyless entry transmitter and a vehicle. More particularly, this invention relates to a method of utilizing many different wireless vehicle control transmitters with many different vehicles.

Typical operation of such a system utilizes a single identification code that is recognized by a vehicle controller. In most instances, only a few transmitters or key fobs are matched to any one vehicle. Therefore, the vehicle controller is only required to maintain and store a few identification codes. Further, conventional key fobs utilize a rolling count as part of an encryption that prevents undesired operation from non-matched key fobs. The rolling count operates by sending information indicative of the number of times a button is activated on the key fob. The vehicle controller also stores a portion of the rolling count and compares the received rolling count with the stored expected rolling count for each key fob. If the rolling count transmitted by the key fob is much different than the expected stored rolling count, or is out of range as is it is referred to in the art, the vehicle controller will not recognize the key fob. An out of range key fob is not a common occurrence when only a few keys are utilized with a single vehicle.

Disadvantageously, out of range rolling counts become a problem when it is desired to utilize a single key fob with multiple vehicles for operation of fleet vehicles. In a fleet application where it is desired to utilize a single key fob to operate multiple vehicles, the rolling count can become out of range for vehicles that are not utilized frequently by a user. One means of dealing with this problem is to store the entire identification code within each vehicle controller for each of the authorized key fobs. However, this solution also significantly increases the time required to authenticate the key fob to undesirable levels.

Accordingly, it is desirable to develop a system and method of authenticating and operating a remote keyless entry system that provides for the recognition of multiple key fobs by multiple vehicle controllers with an acceptable system response time.

### SUMMARY OF THE INVENTION

An example method for sending and receiving transmissions for a remote keyless entry and immobilizer that facilitates operation of multiple transmitters with multiple vehicles is disclosed.

A common secret key code stored in each transmitter and vehicle controller of the system is utilized to encrypt and decrypt information and data transmitted from the transmitter to the vehicle. The secret code is combined with fixed and variable data to generate an encrypted portion of a transmission. The fixed and variable data are also utilized as part of the transmission and are sent in a non-encrypted form. Once received by a vehicle controller, an encryption algorithm is utilized to replicate the received encrypted portion of the transmission. The vehicle controller includes the secret key code, and also receives all the information utilized by the transmitter to generate the encrypted portion of the transmission. The encrypted code generated by the vehicle controller is then compared to the received encrypted portion. If the comparison is favorable, then the desired vehicle operation is performed.

Accordingly, the example system provides for the operation of multiple vehicles and multiple transmitters without storing many different identification codes in each vehicle.

These and other features of the present invention can be best understood from the following specification and drawings, the following of which is a brief description.

### BRIEF DESCRIPTION OF THE DRAWINGS

FIG. 1 is a schematic view of a system for operating multiple vehicles with multiple wireless transmitters.

FIG. 2 is a schematic view of a method of communicating wireless data between a vehicle and a wireless transmitter.

### DETAILED DESCRIPTION OF THE PREFERRED EMBODIMENT

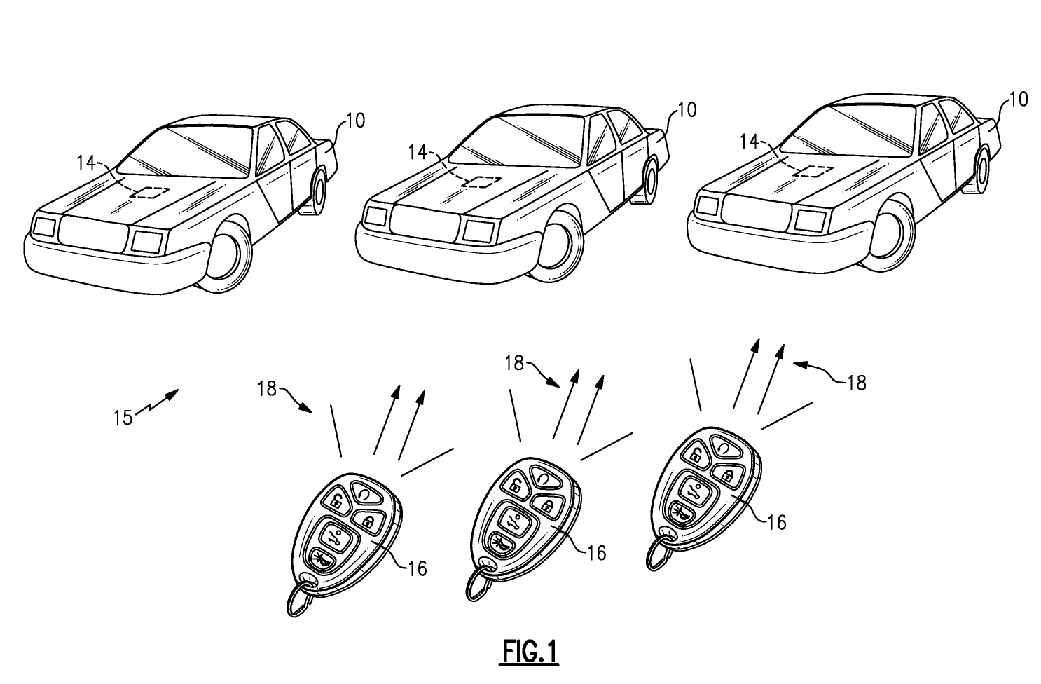

Referring to FIG. 1, an example system for transmitting data for a remote keyless entry (RKE) and immobilization system is generally indicated at 15 and provides operation of multiple vehicles 10 with any one of several corresponding wireless transmitters 16. Each of the transmitters 16 emits a radio frequency (RF) signal 18 to provide for operation of any of the plurality of vehicles 10. Each of the plurality of vehicles 10 includes a vehicle controller 14 for processing the signal 18.

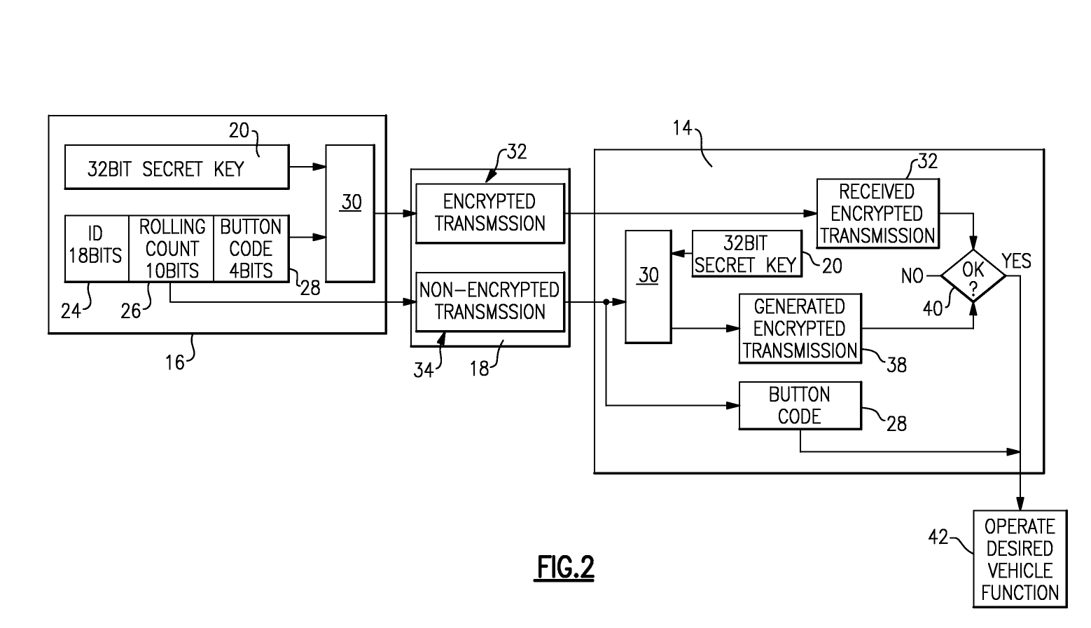

Referring to FIG. 2 with continuing reference to FIG. 1, the transmission 18 between the transmitter 16 and the various vehicle controllers 14 includes an encrypted portion 32 and a non-encrypted portion 34. The encrypted portion 32 is generated from fixed known values and variable data generated by the transmitter 16. The fixed known data values include a secret key data code 20. The secret key data code 20 is a data combination unique to the vehicles 10 and transmitters 16 of the system 15. The secret data code 20 is stored within a memory device within each of the transmitters 16 and the vehicle controllers 10. Each vehicle 10 and transmitter 16 of the example system 15 includes the secret data code 20. The secret data code 20 is the same for each vehicle 10 and transmitter 16 that belongs to the system 15. In this way, only limited memory space is required for each transmitter 16 and vehicle controller 14.

The non-encrypted portion 34 of the transmission 18 is utilized by the vehicle controller 14 to replicate the encrypted portion 32 of the transmission 18. The replicated encrypted transmission 38 is then compared to the received encrypted transmission 32 to verify that the transmission is from an authorized transmitter 16 and that the received commands should be implemented.

Referring to FIG. 2, an example encryption and transmission method and device includes the transmitter 16 that includes a memory storage area that stores the secret key code 20. The example secret key code 20 includes 32 bits of data, although other lengths of data are also within the contemplation of this invention. The secret key code 20 includes data unique to the system and is common to each of the transmitters 16 and vehicle controllers.

The transmitter 16 also includes an identification code 24 that is unique to the specific transmitter 16. A rolling count 26 is stored within the transmitter 16 and is incremented with each press of a button of the transmitter 16. The rolling count 26 provides a variable value that generates a continuously changing value that inhibits unauthorized regeneration of transmissions from the transmitter 16. A button code 28 communicates a desired command to the vehicle controller. The button code 28 is the transmission that the vehicle receives and provides instructions for operation of the vehicle.

In the example transmitter 16, the transmission 18 includes an encrypted portion 32 and a non-encrypted portion 34. The transmitter 16 includes an encryption algorithm 30 that receives inputs from the secret key 20, the transmitter identification code 24, the rolling count 26 and the button code 28. The encryption algorithm 30 processes the input data to generate the encrypted portion 32. The encrypted portion 32 utilizes but does not transmit the secret key 20. The secret key 20 is not transmitted at any time and is utilized only for the encryption process.

The data input and utilized for the encryption process, except for the secret key 20, is also transmitted in non-encrypted form. The non-encrypted portion 34 includes the Id code 24, the entire rolling count 26 and the button code 28. The encrypted portion 32 and the non-encrypted portion 34 are both sent to and received by the vehicle controller 14.

The vehicle controller 14 includes the same encryption algorithm 30 as is present within the transmitter 16. The encryption algorithm 30 within the vehicle controller 14 utilizes the received non-encrypted portion 34 of the transmission 18 to replicate the encrypted portion of the transmission 32. Because the vehicle controller 14 also includes the secret data key 20, the non-encrypted portion 34 of the transmission combined with the secret data key 20 processed by the same encryption algorithm 30 will produce the same encryption as is received. Accordingly, the vehicle controller 14 generates another encrypted transmission and compares the generated encryption 38 with the received encryption 32. If the comparison meets the desired criteria than the transmission is authenticated and the commands communicated by the button code are implemented as is schematically indicated at 42. However, if the comparison indicated at 40 does not result in a desired match, then the transmission is not authenticated and the vehicle operation is not performed.

This method transmits all the data, but for the secret key, required to replicate the encryption performed at the transmitter 16. The encryption is duplicated with the stored secret key 20 and compared to the received encryption. This process does not require multiple storage of identification codes. All that is required is that each device and vehicle stores a common secret key code that is utilized along with the common encryption algorithm to confirm that an approved and authorized transmission is received. As appreciated, the number of data bits and types of data bits can be modified to meet desired application specific operation.

The rolling count 26 is transmitted in the identical form that is utilized to generate the encrypted portion 32 of the transmission. This removes the need for storage of any portion of the rolling count in any of the vehicle controllers. This further prevents the ranging out of any one of the transmitters 16 as it applies to any one of the vehicles.

This transmission system and method of encrypting and decrypting transmissions facilitates the use of many different transmitters with many different vehicles. As each vehicle includes the secret key, it will accept any transmitter that also includes the same secret key 20. Therefore, even if one transmitter 16 has not ever operated one of the many vehicles, but has operated other vehicles many times, the rolling count value, although high, will not prevent operation of any one of the multiple vehicles.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A method of transmitting data for a remote keyless entry system comprising the steps of:
a) generating an encrypted signal utilizing a secret code, a transmitter identification code; and a variable value indicative of a current state of a transmitter;
b) transmitting the encrypted signal for receipt by a vehicle controller with non-encrypted data including the transmitter identification code and the variable value indicative of a current state of the transmitter;
c) receiving both the encrypted signal and the non-encrypted data with the vehicle controller;
d) replicating the encrypted signal at the vehicle controller;
e) comparing the replicated encrypted signal to the received encrypted signal; and
f) initiating a vehicle operation responsive to the received encrypted signal comparing to the replicated encrypted signal within a desired acceptance criteria.

2. The method as recited in claim 1, wherein the variable value indicative of a current state of the transmitter comprises a rolling count indicative of a number of button presses of the transmitter, wherein the same value is utilized to generate the encrypted signal and is transmitted as part of the non-encrypted signal.

3. The method as recited in claim 1, wherein the vehicle controller comprises one of a plurality of vehicle controllers that are disposed within a corresponding plurality of vehicles such that the transmitter is operable with any one of a plurality of vehicles.

4. The method as recited in claim 1, wherein the variable value comprises 32 bits of data that include 18 bits of data utilized to communicate a transmission identification code, 10 bits of data utilized to comprise a rolling count of the number of times a button of the transmitter is pressed and 4 bits of data including a value indicative of a desired operation of the vehicle.

5. The method as recited in claim 4, wherein the entire 10 bits of data for the rolling count is transmitted as non-encrypted data to the vehicle controller.

6. The method as recited in claim 1, wherein the secret code is not part of the non-encrypted signal.

7. A method of authorizing operation of many vehicles with a single transmitter comprising the steps of:
a) storing a secret code value in at least one transmitter and each of a plurality of vehicle controllers of a corresponding plurality of vehicles;
b) generating an encrypted signal responsive to actuation of the at least one transmitter, wherein the encrypted signal is generated utilizing the secret code, command data indicative of a desired vehicle operation, and a rolling count incremented each time a button of the transmitter is depressed;
c)transmitting the encrypted signal and a non-encrypted signal to one of the plurality of vehicle controllers, wherein the non-encrypted signal includes the rolling count, and the command data;
d) creating a generated encrypted signal in the vehicle controller utilizing the stored secret code and the received non-encrypted signal to replicate the received encrypted signal; and
e) comparing the generated encrypted signal with the received encrypted signal and authorizing the desired operation responsive to the comparison fulfilling a desired criteria.

8. The method as recited in claim 7, wherein encrypted signal comprises 32 bits of data.

9. The method as recited in claim 8, wherein all of the rolling code utilized to generate the encrypted signal is transmitted in the non-encrypted signal.

10. The method as recited in claim 9, wherein the rolling code comprises 10 bits of data that are all transmitted to the vehicle controller.

11. The method as recited in claim 7, wherein the secret code value is not transmitted to the vehicle controller.

12. The method as recited in claim 7, wherein the transmission comprises a radio frequency (RF) transmission.

13. The method as recited in claim 7, wherein the non-encrypted signal also includes an identification code for the transmitter that is utilized to generate the encrypted signal.

14. A keyless entry and start system comprising:
a plurality of vehicles including vehicle controllers; and
a plurality of transmitters for communicating with each of the plurality of vehicles, wherein each of the plurality of transmitters transmits an authorization transmission verifiable by each of the plurality of vehicles such that each of the plurality of transmitters facilitates operation of each of the plurality of vehicles.

15. The system as recited in claim 14, wherein each of the plurality of transmitters and the plurality of vehicle controllers includes a common stored secret code.

16. The system as recited in claim 15, wherein each of the plurality of transmitters transmits an encrypted signal and a non-encrypted signal, where the encrypted signal is generated utilizing the common secret code, an identification code unique to the specific one of the plurality of transmitters and a variable value, and the non-encrypted signal comprises the unique identification code and the variable value.

17. The system as recited in claim 16, wherein the variable value includes a value indicative of the number of button presses of the transmitter and the same variable value is utilized to generate the encrypted signal that is sent within the non-encrypted signal.

18. The system as recite in claim 17, wherein the vehicle controller utilizes the stored secrete code along with the non-encrypted signal to generate a second encrypted signal and authorizes operation of a vehicle functions responsive to the received encrypted signal comparing as desired with the generated encrypted signal.
